(19) United States
(12) Patent Application Publication
(10) Pub. No.: US 2007/0074564 A1
(43) Pub. Date: Apr. 5, 2007

(54) METHOD AND DEVICE FOR THE AUTOMATIC MAINTENANCE OF MINIMUM REQUIRED AIR PRESSURE WITHIN A TIRE

(76) Inventors: George Jason Rennich, Knoxville, TN (US); John Philip Rennich, Chattanooga, TN (US)

Correspondence Address: Mr.George Jason Rennich, 12240 Channel Point, Knoxville, TN, 37922, US

(21) Appl. No.: 11/163,113

(22) Filed: Oct. 5, 2005

(51) Int. Cl. G01M 17/02

(52) U.S. Cl. 73/146

(57) ABSTRACT

This is a device for the automatic maintenance of minimum tire pressure. The device is a self contained unit placed inside the cavity of a tire and affixed to the wheel. The unit determines the pressure therein and correlates for temperature. The device also contains an array of elements comprised of an encapsulated propellant and an igniter. If the device detects an under-pressure condition it initiates a reaction within an element. Each element, through this reaction, changes the liquid or solid propellant to a gas, thus increasing the volume of the material and therefore increasing the pressure of the gas in the tire. This process is repeatable up to the number of elements in the array.

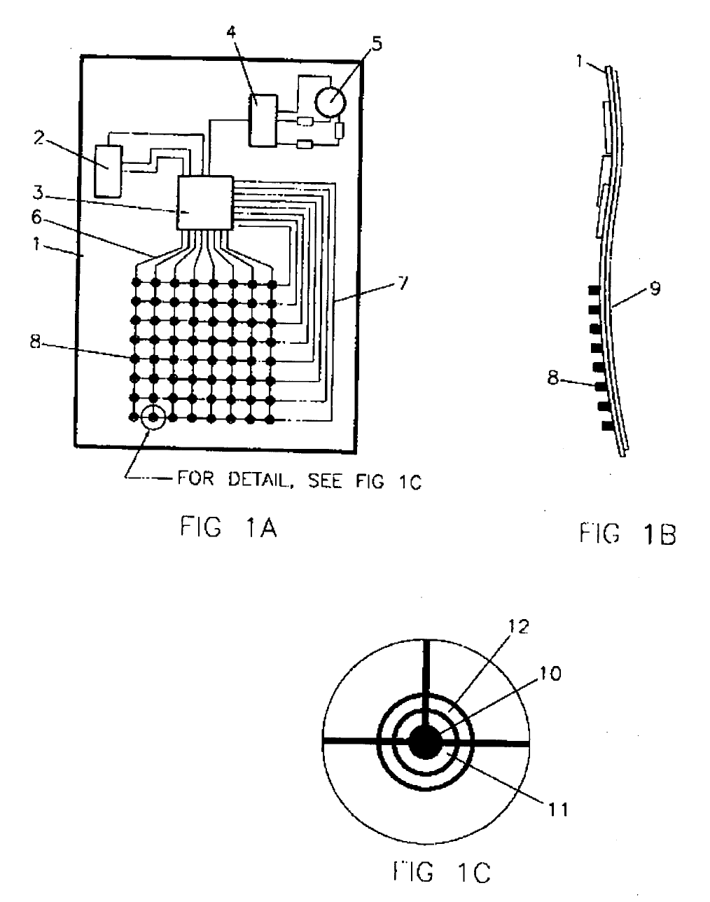

An embodiment of the present invention is illustrated in FIGS. 1A, 1B and 1C. The device consists of a thin sheet of film such as polyimide film based laminate with a conducting layer such as rolled annealed copper foil, a cover sheet and bonding film 1 with double sided tape 9 applied on the non-active side. Such material is used commonly as a flexible electronic circuit board and is used here for the same purpose.

A control circuit that consist of several devices 2,3,4,5 are incorporated on this flexible circuit board. The control circuit incorporates a tire pressure monitoring sensor device such as the MPXY8020 (Freescale Semiconductor, Inc. is located at 6501 William Cannon Drive West, Austin, Tex. 78735). This device is comprised of a capacitive pressure sensing element, a temperature-sensing element, and an interface circuit with wake-up feature, all on a single super small outline package chip 2. The control circuit 2 is modified to communicate with device 3 using common practices within the electronics industry. Information from the tire pressure monitoring sensor is received and processed by a secondary electronic device 3. Device 3 may consist of decoder chips and transistor arrays or other circuits common to the electronics industry. Device 3 triggers the igniters 10. Power for the circuit is supplied by a battery 4 in conjunction with a power supply decoupling capacitor 5. A grid of copper leads running longitudinally 6 and latitudinally 7 intersect at nodes 8. The number of nodes is a multiple of the number of longitudinal and latitudinal leads. The leads initiate at device 13. Each node consists of an igniter 10 and a quantity of gas-producing reactive material 11 and a heat shield 12 to prevent the reactive material from damaging the circuit upon reaction. In the preferred embodiment the reactive material comprises sodium azide (NaN ), ferrous oxide (Fe O), and small amounts of other proprietary additives. Such reactive material is commonly used as a gas generator to inflate airbags.

Although this is the preferred embodiment, other reactive materials may be used.

What is claimed is:

1. A method for maintaining the pressure of the gas within a tire, comprising the steps of:
a. measuring the pressure of the gas within the tire,
b. providing a material selected from the group consisting of solids or liquids,
c. initiating a chemical reaction thereby converting said material to the gaseous state,
d. initiating and sequentially repeating said reaction using separate increments of said material if the pressure of the gas within the tire is below a predetermined pressure, thus conversion of said material increases the gas pressure within the tire to a predetermined minimum pressure.

2. A device for maintaining the pressure of the gas within a tire, comprised of:
a. a pressure measuring device,
b. a material selected from the group consisting of solids or liquids,
c. a plurality of elements of said material,
d. a means for initiating and sequentially repeating a chemical reaction using separate increments of said material if the pressure of the gas within the tire drops below a predetermined pressure whereby the conversion of said material increases the gas pressure within the tire to the predetermined minimum pressure.

3. The device of claim 2 wherein pressure is measured using a capacitive pressure sensing element.

4. The device of claim 2 wherein pressure measurement is adjusted using a temperature sensing element.

5. The device of claim 2 wherein pressure is measured using a strain gauge.

6. The device of claim 2 wherein pressure is measured using a diaphragm.

7. The device of claim 2 wherein pressure is measured using an oscillating microcantilever.

8. The device of claim 2 wherein the material is a propellant.

9. The device of claim 2 wherein the material is a propellant consisting of sodium azide (NaN), ferrous oxide (FeO), and small amounts of other proprietary additives.

10. The device of claim 2 wherein the material is a propellant consisting of black powder.

11. The device of claim 2 wherein the material is a propellant consisting of double-base solid nitrocellulose.

12. The device of claim 2 wherein the material is a propellant consisting of lead styphnate.

13. The device of claim 2 wherein the array is composed of a MEMS micro-thruster array fabricated as a three-layer silicon and glass sandwich, with the middle layer consisting of multiple small propellant cells sealed with a rupturable diaphragm on one side and an igniter on the other.

14. The device of claim 2 wherein the array is constructed using standard lithographic techniques such as those used to manufacture semiconductor chips.

15. The device of claim 2 wherein the reaction is initiated by the combining of a plurality of liquids.

16. The device of claim 2 wherein the reaction is initiated by an increase in temperature.

17. The device of claim 2 wherein the reaction is initiated by an induction of electrical current.

18. The device of claim 2 wherein the reaction is initiated by the combining of a plurality of solids.

19. The device of claim 2, further including an apparatus to prevent over inflation.

20. The device in claim 2, wherein electronic components may vary although achieving the same end. Obvious and common alternative circuits are available within the electronics industry to achieve the goal of controlled and repeatable gas generation.
